(19) United States
(12) Patent Application Publication
(10) Pub. No.: US 2019/0035369 A1
(43) Pub. Date: Jan. 31, 2019

(54) REDUCED VOLUME DRUMS AND COMPONENTS THEREOF

(71) Applicant: John V. Roderick, Marshfield, MA (US)

(72) Inventor: John V. Roderick, Marshfield, MA (US)

(21) Appl. No.: 16/151,777

(22) Filed: Oct. 4, 2018

Related U.S. Application Data
(63) Continuation of application No. 15/711,447, filed on Sep. 21, 2017, now abandoned.
(60) Provisional application No. 62/397,388, filed on Sep. 21, 2016.
(60) Provisional application No. 62/490,205, filed on Apr. 26, 2017.

(51) Int. Cl. G10D 13/02

(52) U.S. Cl. CPC G10D 13/021; G10D 13/028; G10D 13/027; G10D 13/025; G10D 13/022

(57) ABSTRACT

A reduced volume snare drum has a top face and a bottom face; and a snare assembly is releasably secured to the bottom face. The reduced volume snare drum includes a drum shell, a top drumhead hoop for mounting the top drumhead to the drum shell, and at least one snare mount for mounting the snare assembly to one of the drum shell or the top drumhead hoop and in contact with the bottom face. In one embodiment, the top drumhead is fabricated with a three-dimensional knitted fabric having two separate knitted substrates which are joined together by a filament or fiber

### CROSS-REFERENCE TO RELATED APPLICATIONS

The present application is a Continuation Application of U.S. patent application Ser. No. 15/711,447, filed on Sep. 21, 2017, which claims the benefit under 35 U.S.C. § 119(e) of Provisional Patent Application Ser. No. 62/397,388 filed Sep. 21, 2016, and further claims the benefit under 35 U.S.C. § 119(e) of Provisional Patent Application Ser. No. 62/490,205 filed Apr. 26, 2017, the contents of each of which are incorporated herein by reference in their entireties and the benefits of each are fully claimed herein.

### FIELD OF THE INVENTION

The present invention is directed to a reduced volume drum, and more particularly, to a reduced volume drumhead. In particular, the present invention provides the sound and response of a traditional acoustic drum at about fifty percent (50%) to about seventy-five percent (75%) less of audio volume level produced when played.

### BACKGROUND

Musicians that have many years of experience in practicing and teaching drums often suffer from hearing impairment caused by the volume or decibel level produced when a traditional drumset is played. A traditional drumset, marching and orchestral drums also cause difficulties for musicians by raising the volume during solo and group practice and performance. As used herein, the terms “drum” and “drumset” include, but are not limited to, a range of contemporary drums and drumsets (e.g., rock or jazz), marching drums (e.g., field or corps), as well as traditional orchestral instruments (e.g., snare, bass, toms).

Musicians and music industry (“MI”) professionals have noted that the audio volume level, expressed in decibels (“dB”), produced by an acoustic drumset undermined and thus prevented the conventional use of the drumset in live performances unless the drumset was separated or shielded from other musicians or fully enclosed in a separate structure or sound isolation booth. A typical conversation measures about sixty (60) dB, a lawn mower about ninety (90) dB, and a loud rock concert about one hundred twenty (120) dB. In general, sounds above eighty-five (85) dB are harmful to the human ear, depending on how long and how often a person is exposed to them without wearing hearing protection such as earplugs or earmuffs. During a practice or performance, various drumset components typically produce audio volume levels in the range of about ninety (90) dB to about one hundred forty (140) dB.

Conventional snare drums typically include a top drumhead, a bottom drumhead, a shell, and a snare assembly disposed on the bottom drumhead. The snare assembly includes multiple wire, nylon and other material strands that contact the bottom drumhead and vibrate when the top drumhead is struck or played. A conventional snare drum 1000 is shown in FIG. 1 and includes a top face or top drumhead (i.e., a striking surface) (not shown), a bottom face or bottom drumhead 1002, and a drum shell 1004. A snare assembly 1100 is releasably secured to the bottom drumhead 1002 with snare mounts 1006 extending into snare beds 1008 through snare bed recesses 1010 to snare anchors 1012. Snare strands 1014 extend between the snare anchors 1012 and are positioned to contact the bottom drumhead 1002.

The inventor has determined that modification of a drum itself does not provide a substantial reduction of the volume level and instead unsatisfactorily alters the sound and feel of the drum. Such methods or techniques employed by the inventor included: muting the striking surface or drumhead with a drum mute; altering the materials from which a drum rim or hoop is fabricated; altering the materials from which a drum shell is fabricated; and altering the edge shape of a drum bearing. Moreover, known materials from which typical drum heads are fabricated have inherent problems due to the one or two ply traditional nylon mesh or screen substrate material having a limited tonal range and hard tactile responses.

Some known reduced volume drumheads are made using nylon mesh as a striking surface. Examples include the REMO® SILENTSTROKE® mesh drumhead used primarily on a traditional drumset to reduce its volume; and the Roland “Power Ply” mesh drumhead used primarily with digital drum systems, external drum triggers, rubber trigger cymbals and digital drum audio. (REMO® and SILENTSTROKE® are registered trademarks of REMO, Inc., a California corporation; Roland Corporation is a Japanese corporation). When used to reduce the sound of a traditional acoustic snare drum, these known prior art examples have inherent problems in reproducing the actual sound characteristics of the traditional acoustic snare drum.

The inventor has concluded that, preferably, the volume level of a drumset will be reduced to allow the drum set to remain a viable instrument moving forward and that the reduction in the volume level must be achieved without altering the end-user experience (i.e., the drummer, other MI professionals and the listening audience). What is needed are drums and percussion instruments that look, sound and play like traditional acoustic drums and percussion instruments but that produce much lower audio volume levels.

### SUMMARY

In one aspect, the present invention is directed to a reduced volume snare drum comprising: a top drumhead having a top face and a bottom face; and a snare assembly releasably secured to the bottom face. In one embodiment, the reduced volume snare drum further comprises: a drum shell; a top drumhead hoop for mounting the top drumhead to the drum shell; and at least one snare mount for mounting the snare assembly to one of the drum shell or the top drumhead hoop and in contact with the bottom face. In one embodiment, the top drumhead comprises: a three-dimensional knitted fabric having two separate knitted substrates which are joined together by a filament or fiber.

In one aspect, the present invention is directed to a reduced volume drum comprising: a top drumhead fabricated from a three-dimensional knitted fabric having two separate knitted substrates which are joined together by a filament or fiber.

### BRIEF DESCRIPTION OF THE FIGURES

FIG. 1 is a bottom isometric view of a typical reduced volume snare drum.

FIG. 2 is a top view of one embodiment of a reduced volume drum in accordance with one embodiment of the present invention.

FIG. 3 is a view of the underside of the top of the reduced volume drum of FIG. 2.

FIG. 4 is a bottom view of the reduced volume drum of FIG. 3.

FIG. 5 is a front perspective view of another embodiment of a reduced volume drum in accordance with the present invention.

FIG. 6 is a front perspective view of another embodiment of a reduced volume drum in accordance with the present invention.

FIG. 7 is a cross-sectional view of a material from which a drumhead in accordance with one embodiment of the present invention is fabricated.

FIG. 8 is an isometric view of a drumhead of the reduced volume drum of FIGS. 5 and 6.

FIG. 9 is a top perspective view of a reduced volume drumset having reduced volume drums in accordance with one embodiment of the present invention.

### DETAILED DESCRIPTION

The present invention is directed to a reduced volume drumset that maintains core elements of a conventional drumset without compromising the feel, sound or appearance of the instrument. Embodiments of the present invention include reduced volume drums and reduced volume drumheads that produce a drum sound that blends with the other drumset components without compromising the appearance, acoustic tone or the physical (i.e., tactile) stick response produced from the drum.

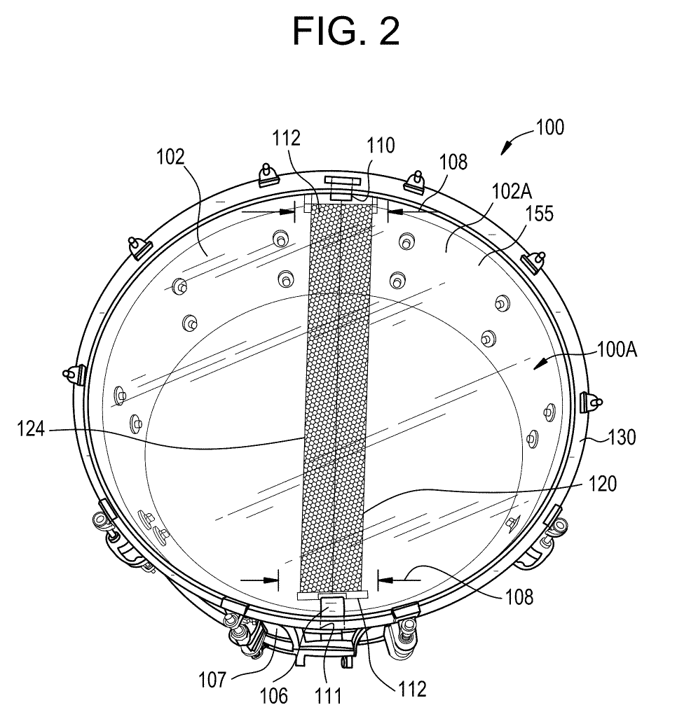

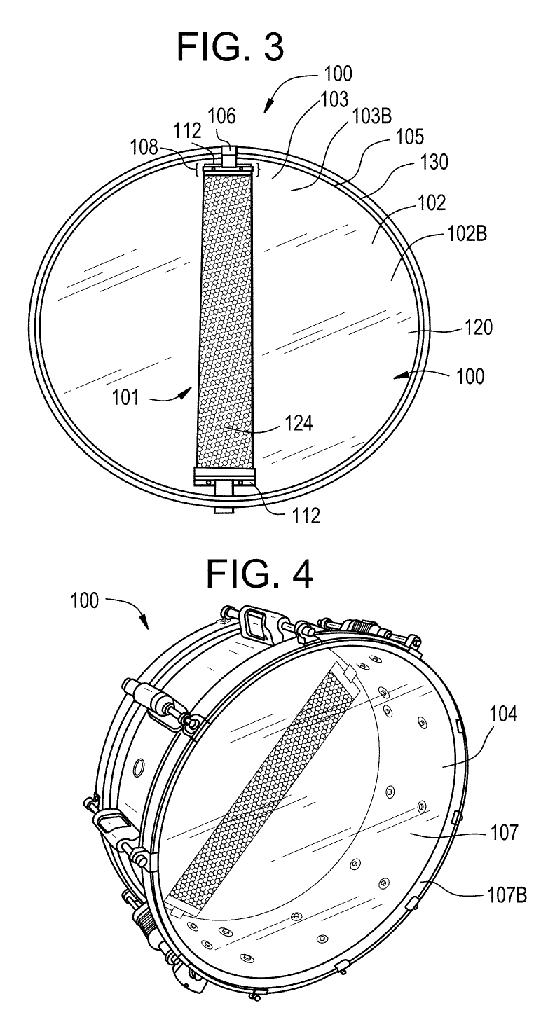

One embodiment of an exemplary reduced volume drum in accordance with the present invention is a reduced volume snare drum shown in FIGS. 2, 3 and 4, and is referred to herein as RVSD 100. The RVSD 100 is configured to replace a conventional acoustic snare drum and reduce the audio volume level, expressed in decibels (“dB”), produced by the conventional snare drum by about fifty percent (50%) to about seventy-five percent (75%) when played. The RSVD 100 includes a top face or top drumhead 102 having a striking surface or top face 102A (FIG. 2) and a top face underside or bottom face 102B (FIG. 3). The top drumhead 102 is mounted on to a drum shell 107 and secured to a first end or top end 107A of the drum shell 107 by a drum rim or top drumhead hoop 130. The RSVD 100 further includes resonant face or bottom drumhead 104 mounted at a second end or bottom end 107B of the drum shell 107. A snare assembly 120 is releasably secured to the bottom face 102B with snare mounts 106 extending into snare beds 108 through snare bed recesses 110 to snare anchors 112. Snare wire, nylon and/or other material wires or strands 124 extend between the snare anchors 112 and are positioned to contact the bottom face 102B of the top drumhead 102. In one embodiment, the snare mounts 106 are integrally formed with the hoop 130. In one embodiment, the snare mounts 106 extend through a corresponding aperture 111 formed in the hoop 130. In one embodiment, the snare mounts 106 extend over corresponding recesses (not shown) in the top end 107A of the drum shell 107.

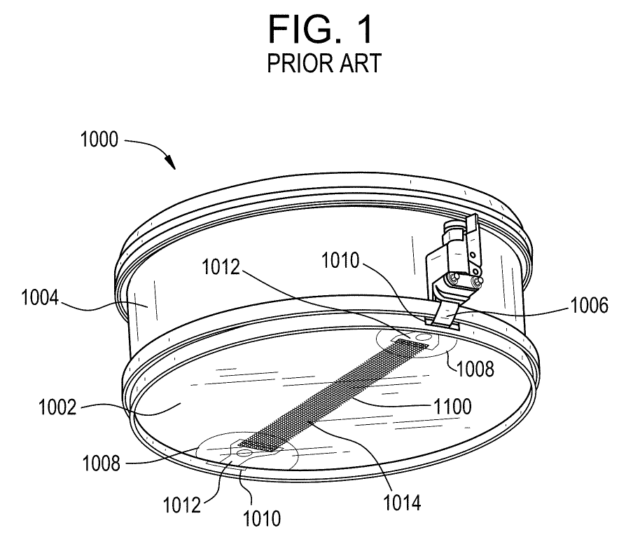

In one embodiment, a reduced volume snare drumhead, referred to herein as RVSDH 100A, includes the top drumhead 102, the bottom drumhead 104, the snare assembly 120 secured thereto as described with reference to the RSVD 100 wherein the snare 124 contact the bottom face 102B of the top drumhead 102. Thus, the RVSDH 100A may be retrofit or assembled onto a conventional snare drum, for example the snare drum 1000 shown in FIG. 1, to reduce its audio volume level when played in a like manner as the RSVD 100.

Unlike the conventional snare drum 1000 shown in FIG. 1, the RVSD 100 moves the interaction of the snare wires 124 to the top drumhead 102 of the RSVD 100 instead of the conventional placement of the snare strands 1014 in contact with the bottom drumhead 1002. In one embodiment, the RSVD 100 provides the sound and response of a traditional acoustic snare drum with at least about fifty percent (50%) to about seventy-five percent (75%) less of audio volume level produced when played.

In one embodiment and as shown in FIG. 3, the top drumhead 102 incorporates a striking membrane or mesh drumhead “batter head” 103, such as for example a nylon mesh, having a striking surface or top face (not shown) and a top underside or bottom face 103B. The snare wires 124 are mounted to an outer ring 105 of the mesh drumhead 103 just below the bottom face 103B at a center line position 101 of the diameter of the drumhead 102. When the mesh drumhead 103 is struck, it activates the snare wires 124 on the bottom face 103B of the mesh drumhead 103 producing a traditional sound of a snare drum but at a greatly reduced audio volume level. The bottom drumhead 104 produces both pitch and resonance. In one embodiment, the bottom drumhead 104 is a traditional plastic or mylar drumhead.

Several procedures can be applied to the striking surface 102A to fine-tune the tone, attack and tactile response of the RVSD 100 for each diameter and type of drum (in addition to a snare drum) to which the reduced-volume head is mounted. These include, for example: (i) spraying a coating on the full surface of one or both of the top face 102A and bottom face 102B of the top drumhead 102; (ii) spraying a coating in-line (e.g., at the centerline position 101) and the same width of snare assembly 120 on the bottom face 102B of the top drumhead 102; and (iii) spraying thin rings on one or both of the top face 102A and bottom face 102B of the top drumhead 102 at pre-determined intervals based on the diameter of the top drumhead 102. Variations of the RVSD 100 can mirror traditional (acoustic) snare drum diameters and depths, some types known as “piccolo” and “tenor” snare drums, thus reproducing such sounds.

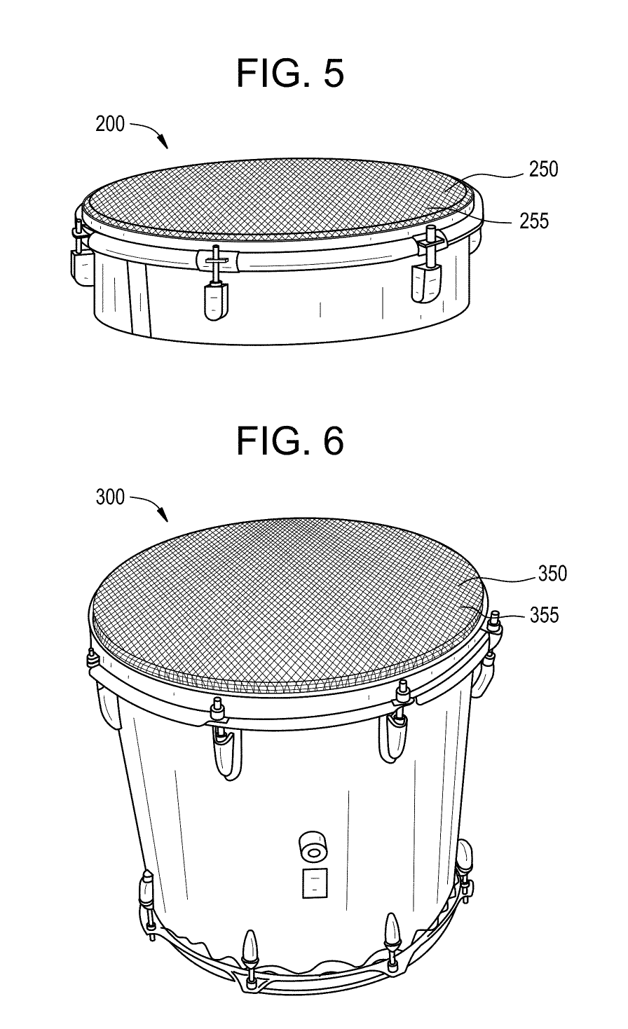

One embodiment of a reduced volume drum in accordance with the present invention is shown in FIG. 5 and is referred to herein as RVD 200. Another embodiment of a reduced volume drum in accordance with the present invention is shown in FIG. 6 and is referred to herein as RVD 300. Like the RVSD 100, the RVD 200 and RVD 300 are configured to replace corresponding traditional drums and drumheads and reduce the audio volume level produced by the snare drum when played by about fifty percent (50%) to about seventy-five percent (75%). The RVD 200 includes a drumhead 250 and the RVD 300 includes a drumhead 350. In one embodiment, the drumhead 250 and/or 350 is fabricated from a fabric mesh that is mounted onto the respective RVD 200 and/or RVSD 300 and tensioned to the pitch of a conventional drum to replicate the tone of the conventional drum.

As a result of extensive testing and experimentation, the inventor discovered that the material from which a drumhead is fabricated provides an opportune feature of a drum that can be improved upon to achieve a reduced volume drum in accordance with embodiments of the present invention. As a result of further extensive testing and experimentation, the inventor has discovered that fabricating a drumhead from a fabric mesh meeting a range of preferred performance criteria and exhibiting one or more preferred property characteristics provides a reduced volume drumhead in accordance with embodiments of the present invention. Such performance criteria include, for example, reliable haptic feedback under tension while dampening vibration and sound. Such property characteristics include, for example, improved noise permeability, improved rebound elasticity or spring-back effect, improved pressure distribution, even reinforcement, high shock absorption, low weight, suitable malleability, suitable coating and laminating properties, and long service life.

The inventor has discovered that such mesh fabrics are known in the automobile and bedding manufacturing arts as a “spacer fabric” used primarily in climate-controlled mattresses and car seats because such fabrics facilitate air flow. Other uses of spacer fabric include running shoes and hiking backpacks. The spacer fabric is a three-dimensional knitted fabric having two separate knitted substrates which are joined together by a filament or fiber. The inventor has further discovered that one such exemplary fabric is commercially available as 3mesh® fabric from Mueller Textil GmbH of Germany.

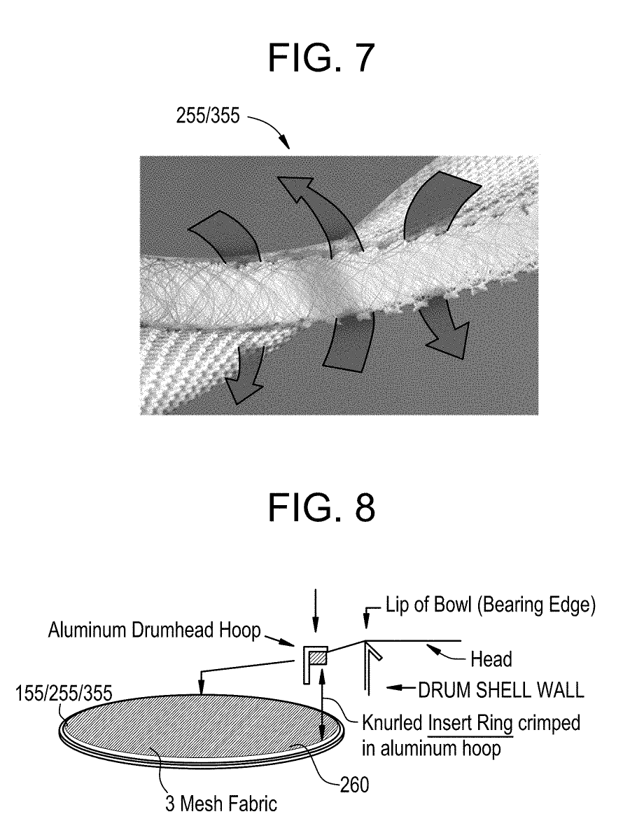

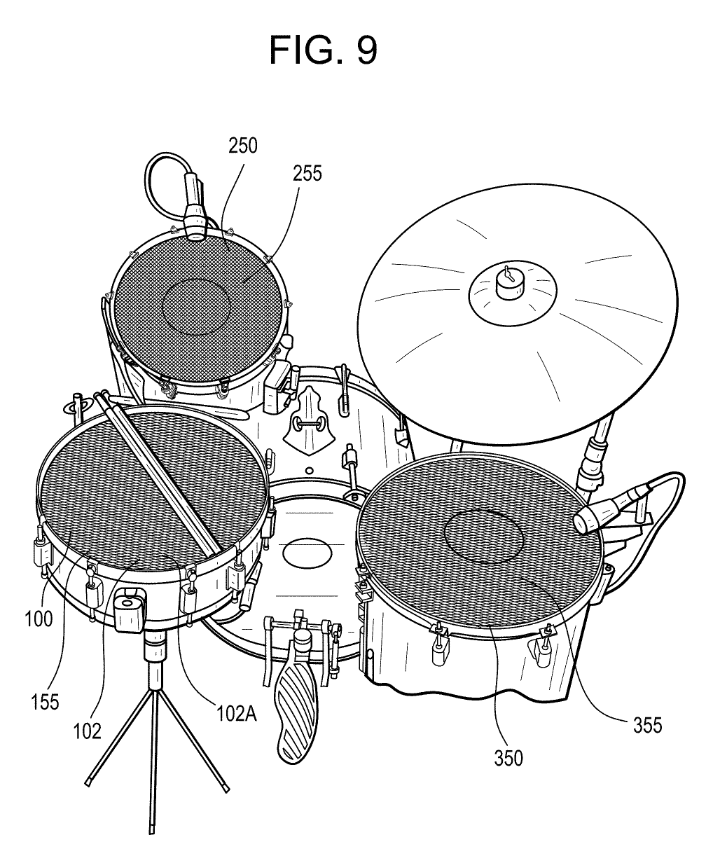

In one embodiment, the drumhead 250 is fabricated from spacer fabric 255 (i.e., a three-dimensional knitted fabric having two separate knitted substrates which are joined together by a filament or fiber); and in one embodiment, the drumhead 350 is fabricated from spacer fabric 355. In one embodiment as shown in FIG. 9, the top face 102A of the top drumhead 102 of the RSVD 100 is fabricated from a spacer fabric 155. In one embodiment, the spacer fabric 155, 255 and/or 355 is 3mesh® fabric. An image of a cross section of the 3mesh spacer fabric is shown in FIG. 7.

In one embodiment, the spacer fabric 155, 255 and/or 355 ranges in thickness up to about twenty-five (25) mm. In one embodiment, the spacer fabric 155, 255 and/or 355 ranges in thickness from about two (2) mm to about ten (10) mm. In one embodiment, the spacer fabric 155, 255 and/or 355 ranges in thickness from about two (2) mm to about five (5) mm.

In one embodiment and as shown in FIG. 8, the spacer fabric the spacer fabric 155, 255 and/or 355 is pre-stretched and crimped into a round aluminum channel or hoop 260 using high pressure against a steel ring, a standard high-tension drumhead construction technique. In one embodiment, further post-crimping applications can fine-tune the tonal and tactile response produced to replicate a traditional contemporary plastic drumhead but at about fifty percent (50%) to about seventy-five percent (75%) less of audio volume level produced when played. Such post crimping procedures include: spraying a coating on the bottom (under-side) of the formed (crimped) drumhead 102, 250 and/or 350; spraying thin rings on the bottom (under-side) at intervals of the formed (crimped) drumhead 102, 250 and/or 350; spraying a coating on the top (striking-side) center of the formed (crimped) drumhead 102, 250 and/or 350 as shown in FIG. 9.

The reduced volume drum and/or the reduced volume drumhead can be employed in various diameters and depths in a range of musical or percussion applications including but not limited to a drumset, marching and orchestral drum settings. In one embodiment, the reduced volume drum and/or the reduced volume drumhead is provided as an after-market product and offered in retail packaging in a variety of sizes (diameters), such as for example, ten (10) to eighteen (18) inch sizes. In one embodiment, the reduced volume drum and/or the reduced volume drumhead is provided as an original equipment manufacturer (“OEM”) or private label (“P/L”) product and offered, for example, as a striking/tone generation surface (drumhead) within an acoustic, electronic digital (“A-E-D”) drumset or “Hybrid” drumset. In one embodiment, the reduced volume drum and/or the reduced volume drumhead is provided for end-user musical applications, such as for example: (i) education and practice; home, public, private and college; (ii) recording and production at home, at a professional studio, or live; and (iii) performances including at a house of worship, live stage, or musical theatre (orchestra pit).

The present invention provides a reduced volume drum and a reduced volume drumhead without compromising the appearance, acoustic tone or haptic response produced from the drum. The present invention also provides a reduced volume drum and a reduced volume drumhead with improved drum tone and wider tonal frequency (range and depth). The present invention further provides a stick, mallet, rod or brush contact which is similar to a traditional drumhead. The present invention also replicates the look of a traditional drumhead and easily mounts on a drum in the same manner as a traditional drumhead.

Although this invention has been shown and described with respect to the detailed embodiments thereof, it will be understood by those skilled in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the appended claims.

What is claimed is:

1. A reduced volume snare drum comprising:
a top drumhead having a top face and a bottom face; and
a snare assembly releasably secured to the bottom face.

2. The reduced volume snare drum of claim 1, further comprising:
a drum shell;
a top drumhead hoop for mounting the top drumhead to the drum shell; and
at least one snare mount for mounting the snare assembly to one of the drum shell or the top drumhead hoop and in contact with the bottom face.

3. The reduced volume snare drum of claim 1, the top drumhead comprising:
a three-dimensional knitted fabric having two separate knitted substrates which are joined together by a filament or fiber.

4. A reduced volume drum comprising:
a top drumhead fabricated from a three-dimensional knitted fabric having two separate knitted substrates which are joined together by a filament or fiber.
